(19) United States
(12) Patent Application Publication
(10) Pub. No.: US 2013/0173316 A1
(43) Pub. Date: Jul. 4, 2013

(54) Mobile Ticket Application

(71) Applicant: Rajesh Agrawal, Kendall Park, NJ (US)

(72) Inventor: Rajesh Agrawal, Kendall Park, NJ (US)

(21) Appl. No.: 13/711,899

(22) Filed: Dec. 12, 2012

Related U.S. Application Data
(60) Provisional application No. 61/581,883, filed on Dec. 30, 2011.

(51) Int. Cl. G06Q 10/02

(52) U.S. Cl. CPC G06Q 10/02
USPC 705/5

(57) ABSTRACT

A method of providing virtual tickets on a mobile communications device running a customized app. The app connects to a central server via a wireless network to purchase a transportation ticket that is valid for travel on a selected route for a selected period of time. The ticket is paid for by an electronic payment. An encrypted copy of the ticket is stored on the mobile device. When used, the app checks if the terms and conditions of the ticket are being complied with before being displayed. If the ticket is compliant, a copy of it is displayed on the mobile devices screen along with a corporate identifier, the selected route and a unique identification string. If the ticket is not compliant, the display is overlaid with a red cross or some other indicator of invalidity.

### CLAIM OF PRIORITY

This application claims priority to U.S. provisional patent application 61/581,883 filed on Dec. 30, 2011, the contents of which are hereby included by reference in their entirety.

### FIELD OF THE INVENTION

The invention relates to mobile telephone electronic ticket applications, and more particularly, to methods and systems of selling and authorizing access to public or private commuter transport using smart phones.

### BACKGROUND OF THE INVENTION

As mobile phone use has grown over the last decade, their use for functions other than speech or text communication has grown. Mobile ticketing is one such application and typically involves purchasing a ticket for travel on a transport system by sending a text message to a particular number. An authorization code is delivered that may, for instance, be a number or image to be displayed or read by a suitable reader on the transit system. In such a simple system, the ticket may, for instance, be charged to the mobile phone account of the mobile phone owner.

Although such systems offer the cost and energy savings of paperless ticketing, a major drawback of such a simple system is that the telephone operator controls the charging. Because of this, the phone system operator typically takes a 40% cut of the total fee, making this an expensive way for transit systems to collect revenue.

With the recent growth of e smart phone use, i.e., of phones having more complex operating systems that are capable of running sophisticated application modules, improved models for mobile ticketing are possible, such as the application based mobile ticket system and method of this invention.

Using the application of this invention, it may be possible to buy tickets for extended periods of time and allow payment for the tickets to be made using electronic payment systems other than the mobile operator. The application running on the mobile device may also act as a ticket verification or validation system, as described in more detail below.

### DESCRIPTION OF THE RELATED ART

The relevant prior art involving mobile ticketing includes:

U.S. Pat. No. 6,690,794 issued to Terao et al. on Feb. 10, 2004 entitled “Electronic ticket system” that describes an electronic ticket system for virtually preventing forgery, copying and other unauthorized uses of electronic tickets; for proving to a third party the contents of an electronic ticket contested between a user and an issuing party; and for protecting users' anonymity upon ticket use. The system comprises a ticket creating and issuing device, a ticket proving device, and a ticket verification device. A ticket creating unit in the ticket creating and issuing device creates specifications of a ticket representing a predetermined service or product in response to a ticket creating request. A ticket issuing unit of the ticket creating and issuing device, in reply to a ticket issuing request, issues the corresponding ticket using as input a ticket identifier, a proving identifier, a ticket specification identifier, and ticket added information. The ticket proving device gets a ticket issued by the ticket issuing unit and communicates with the ticket verification device to prove the possession of the ticket. The ticket verification device has a ticket verifying procedure and, on getting the ticket identifier created by the ticket creating unit, communicates with the ticket proving device to verify the ticket.

U.S. Pat. No. 7,392,226 issued to Sasaki et al. on Jun. 24, 2008 entitled “Electronic ticket, electronic wallet, and information terminal” that describes a network electronic ticket 1003 is provided in an electronic ticket 1000. Start page data 1016, a ticket owner secret key 1017, an electronic ticket possession certificate 1018, and a network service program 1019 are provided in the network electronic ticket 1003, the network service program 1019 controls various types of processing and an electronic ticket storage terminal, and the ticket owner secret key 1017 and the electronic ticket possession certificate 1018 are used for authentication processing with an information providing apparatus on a network, whereby it is made possible to connect to the network from the electronic ticket itself and receive information service.

U.S. Pat. No. 8,036,386 issued to Katayama on Oct. 11, 2011 entitled “System and method for providing electronic ticket, and electronic ticket vending apparatus and mobile telephone therefor” that describes an electronic ticket providing system capable of distributing and browsing the information relating to a ticket can be realized while maintaining the security and transferability of an IC card. The electronic ticket information is divided into formal ticket data and provisional ticket data. The formal ticket data includes authentication information for admission, ticket notation information, and authentication information for acquisition of information for a ticket owner. The provisional ticket data includes the ticket notation information, and authentication information for acquisition of information for a ticket purchase requester. The electronic ticket information is distributed from an electronic ticket vending server to a mobile telephone over a communications network. In the mobile telephone, the formal ticket data is stored in a removable storage medium such as an IC card, etc. having high security and transferability, and the provisional ticket data is stored in the internal memory. In the electronic ticket vending server, ticket related information is transmitted if it is confirmed that the provisional ticket data is stored according to the authentication information for acquisition of information for a ticket purchase requester in the provisional ticket data.

U.S. Pat. No. 7,690,044 issued to Taniguchi et al. on Mar. 30, 2010 entitled “Medium storing program selecting electronic ticket, electronic ticket processing apparatus and electronic ticket selection method” that describes one or more computer-readable media on which is stored a program for selecting an optimum electronic ticket among a plurality of electronic tickets for imparting rights of use of content, the stored program causing a computer to execute functions comprising: extracting a plurality of electronic tickets corresponding to a content; and selecting the optimum electronic ticket among the extracted electronic tickets by comparing conditions of use of content included in the respective extracted electronic tickets.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to methods and apparatus of providing virtual tickets.

In a preferred embodiment, a mobile communications device having an attached display screen may be used to download and run a customized application or app. The mobile communications device may, for instance, be but is not limited to, a smart phone.

The app may, for instance, have programmed instructions for enabling the mobile communications device to perform at least the following functions:

The ability to be used to contact a central server or servers via a network such as, but not limited to, a wireless network.

The ability to be used to purchase a transportation ticket that may, for instance, be valid for travel on, for instance, a service such as, but not limited to, a bus, a train, a ferry, a plane, or a train, or a combination thereof. The transportation may for a selected route and it may also be valid for a selected period of time such as, but not limited to, a number of hours, days, weeks or years, and may be valid for multiple or single rides. The transportation ticket may be purchased from the central server in return, for instance, for providing an agreed electronic payment by a suitable electronic payment method such as, but not limited to, a PayPal™ account, an online credit card payment system, or some combination thereof.

The ability to be used to store a copy of the transportation ticket, preferably in an encrypted form.

The ability to be used to check if the terms and conditions of the stored transportation ticket are being complied with. The app may, for instance, check if a current date and time are within the selected period of time of the transportation ticket.

The ability to be used to display the transportation ticket on the mobile communications device's display screen. In a preferred embodiment, this display, if the ticket is compliant, may also include elements such as, but not limited to, a corporate identifier, the selected route the transportation ticket is valid for and a unique encoded identification string, or some combination thereof.

If the transportation ticket is, for some reason, not compliant with the conditions of its purchase, the display of the transportation ticket may, for instance, be overlaid with an indicia indicative of invalidity such as, but not limited to, a red cross, a red circle with a line through it or some combination thereof.

Therefore, the present invention succeeds in conferring the following, and others not mentioned, desirable and useful benefits and objectives.

It is an object of the present invention to provide a paperless method of purchasing transport tickets, including tickets valid for a day, a week, a month or a year.

It is another object of the present invention to provide access to transit route information, including schedules, changes to schedules and travel alerts.

Yet another object of the present invention is to provide one-click renewal of a transport ticket for a further period of time.

Still another object of the present invention is to automatically receive SMS alerts of delays or chances to schedule.

One further object of the invention is to integrate the app with a typical smart phone's other capabilities, such as, but not limited to, their GPS and mapping capabilities, to provide directions from the user's current location to the boarding point of the service that the transport ticket is valid.

### BRIEF DESCRIPTION OF THE DRAWINGS

FIG. 1 shows a schematic overview of a method of providing virtual tickets of this invention.

FIG. 2 shows a schematic overview of the use of a virtual ticket of this invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

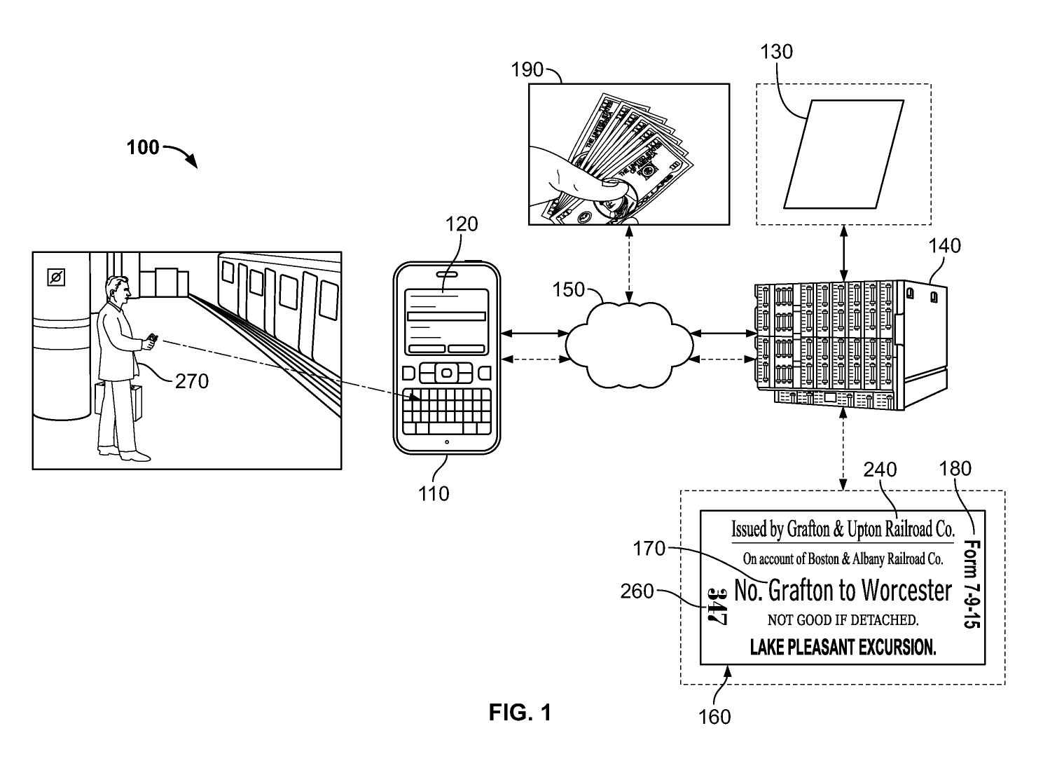

FIG. 1 shows a schematic overview of a method of providing virtual tickets of this invention.

In a preferred embodiment, a mobile communications device 110 that may, for instance, be a smart phone, may be used to connect a passenger 270 to a central webserver 140 via a wireless network 150 in order to download a customized app 130. The mobile communications device 110 preferably has a suitable resolution display screen 120.

The customized app 130 may then be run on the mobile communications device 110 in order for the passenger 270 to access the central webserver 140 and now order a transportation ticket 160. The transportation ticket 160 may, for instance, be for a specified route and be valid for a specific period of time. The transportation ticket 160 may, for instance, be paid for by means of an agreed electronic payment 190. The agreed electronic payment 190 may, for instance, be made using an electronic payment system such as, but not limited to, a PayPal™ account, an electronic credit card system, an electronic bank account, a credit or debit card number and authorization code resident on said mobile communications device, or some combination thereof.

Once purchased, a copy of the transportation ticket 160 may be stored on the mobile communications device 110. In a preferred embodiment, the stored version of the transportation ticket 160 may be suitably encrypted to prevent tampering. The copy of the transportation ticket 160 may include information such as, but not limited to, the selected route 170, a selected period of time 180, a corporate identifier 240 and a unique encoded identification string 260 or some combination thereof.

In a preferred embodiment, the wireless network 150 may be, or may include, a suitable wireless cellular network.

In a preferred embodiment, the customized app 130 may also be used to access other relevant information such as, but not limited to, to transport schedules, route maps, schedule changes, transit alerts, prices and special offers or some combination thereof. The customized app 130 may, for instance, automatically download and store a schedule for the selected route when a transportation ticket 160 is purchased, and store that schedule locally on the mobile communications device 110. The customized app 130 may also automatically receive SMS messages with alerts of current delays or changes to schedule on the selected route.

In an alternate embodiment, the customized app 130 may also be used to provide advertising to the display screen 120 as a means of offsetting costs.

In a preferred embodiment, the customized app 130 may enable a user to perform a one-click renewal of the transportation ticket for a further period of time that may correspond to the initially selected period of time.

In a preferred embodiment, the central webserver 140 may monitor the actual use of the transportation ticket and collect data on ridership patterns such as, but not limited to, how ridership volume varies with time, day of the week, month of the year, or some combination thereof. The central web server may also be able to monitor the effect of weather or major events, such as, but not limited to, sporting events or election days, and be able to use this data to predict future transport requirements, such as, but not limited to, how much service to provide at a particular time on a particular day. The data may be collected in real time, and may assist planning in real time or in an emergency.

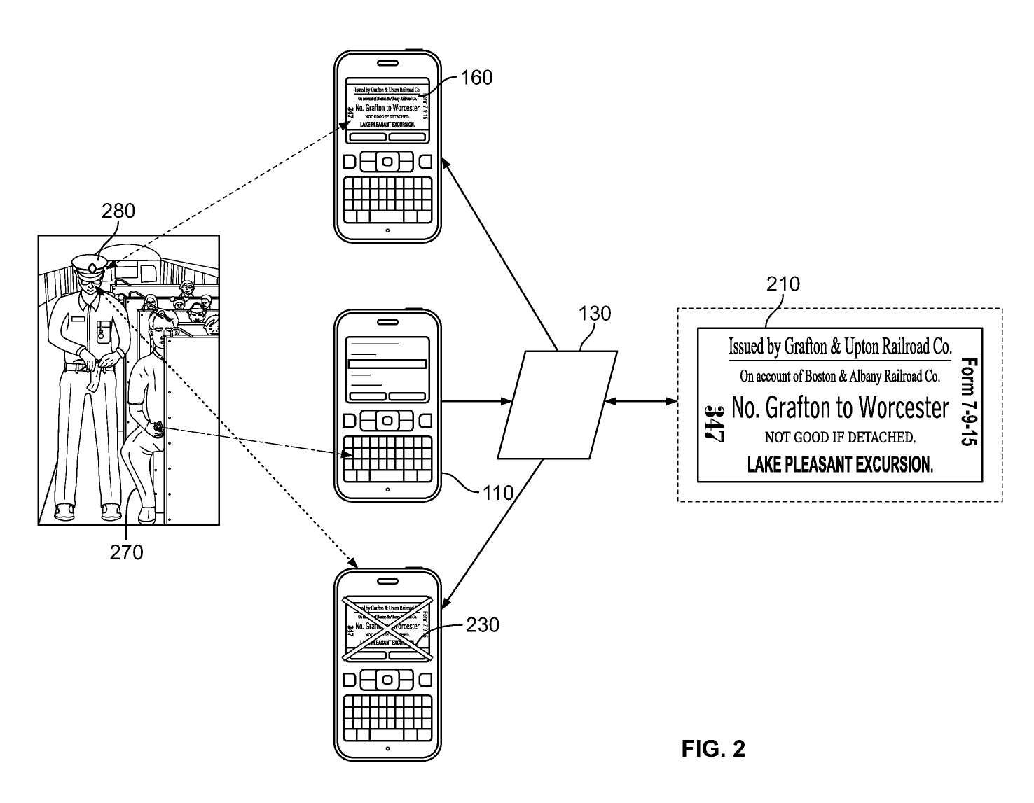

FIG. 2 shows a schematic overview of the use of a virtual ticket of this invention.

A passenger 270 may use the mobile communications device 110 to display a transportation ticket 160 to a transit inspector 280.

In a preferred embodiment an encrypted form 210 of the transportation ticket 160 may be stored locally on the mobile communications device 110. The customized app 130 may, for instance, first check if the conditions of the transportation ticket 160 comply with the current date and time, i.e., if the current date and time fall within the period of time 180 selected at the time of purchase. In a preferred embodiment, if the transportation ticket 160 decrypted from the encrypted form 210 is compliant, the customized app 130 may then display the transportation ticket on the mobile communications device's 110 display screen.

If, on the other hand, the transportation ticket 160 is not compliant, the display of the transportation ticket may be overlaid with an indicia indicative of invalidity such as, but not limited to, a prominent red cross 230, or a red circle with a line through it or some combination thereof.

Whether valid or invalid, the display of the transportation ticket 160 may include other details such as, but not limited to, the selected route 170, the selected period of time 180, a corporate identifier 240 and a unique encoded identification string 260.

In an alternate embodiment, the customized app 130 may periodically download the same random number to all of the transportation tickets for a selected route. This number would provide the transit inspector 280 with an additional verification the transportation ticket 160 is valid.

In a further alternate embodiment, the mobile communications device 110 may use an internal GPS signal to verify that the passenger 270 is currently in a geographical location that conforms to the selected route 170.

In a further embodiment of the invention, the app may be integrated with a typical mobile device's other capabilities, such as, but not limited to, their GPS and mapping capabilities, to provide further services such as, but not limited to, directions from the user's current location to the boarding point of the service that the transport ticket is valid.

In another embodiment of the invention, the app may send an alert to social media, such as but not limited to, twitter, facebook, linked in, etc., from the ticket. For instance, if the 5:00 pm train from Boston to New York is running an hour late, this alert could be sent to all chosen social media.

Additionally, the app may provide an ability to have a circle of friends on the ticket, with which the user communicates via the ticket and central webserver. For instance, when the user boards the train, bus or other transport, they can check in using the ticket with the identification of the transportation they're using. The friends in the circle would then be notified. For instance, a user could designate the circle of friends. The user would then board the 5:00 pm train from Boston to New York. By checking in at the train station with his ticket, he would cause an automatic message to be sent to the circle of friends letting them know he's on that particular train. The message could be sent directly to their smart phones as a text message, twitter message, email message, or communicated using any media that the app can access.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A method of providing virtual tickets, comprising:
providing a mobile communications device having an attached display screen; downloading and running a customized app on said mobile communications device, said customized app comprising programmed instructions for enabling said mobile communications device to perform at least the following functions:
contacting a central server or servers via a wireless network;
purchasing from said central server or servers a transportation ticket valid for travel on a selected route for a selected period of time, in return for providing an agreed electronic payment;
storing said transportation ticket in an encrypted form;
checking if a current date and time is compliant with said selected period of time, and, if compliant, display said transportation ticket on said display screen, and if not compliant, display said transportation ticket overlaid with an indicia indicative of invalidity, and wherein said ticket displays at least a corporate identifier, said selected route and a unique encoded identification string.

2: The method of claim 1 wherein said mobile communications device is a smart phone.

3: The method of claim 1 wherein said functions further include access to transport schedules.

4: The method of claim 1 wherein said functions further include a one-click renewal of said transportation ticket on said selected route for a further period of time corresponding to said selected period of time.

5: The method of claim 1 wherein said customized app automatically downloads a schedule of said selected route and stores said schedule on said mobile communications device.

6: The method of claim 1 wherein said customized app automatically receives SMS messages with alerts of current delays or changes to schedule on said selected route.

7: The method of claim 1 further incorporating automatic validation of the transportation ticket when the mobile communications device is in communication with the central server.

8: The method of claim 7 further comprising downloading a periodically changed random number to all of said transportation tickets for said selected route.

9: The method of claim 1 wherein said agreed electronic payment comprises using a credit or debit card number and authorization code resident on said mobile communications device.

10: The method of claim 1 further incorporating automatic validation of the transportation ticket using a GPS generated current geographical location to confirm that the mobile communications device is currently within a geographic vicinity that conforms to the selected route.

11: The method of claim 1 further incorporating integrating the customized app with the mobile device's GPS and mapping capabilities to provide directions from the user's current location to a boarding point of the service for which the transport ticket is valid.
